(19) United States
(12) Patent Application Publication
(10) Pub. No.: US 2006/0069595 A1
(43) Pub. Date: Mar. 30, 2006

(54) Business system management procedures research and analysis methodology

(75) Inventors: Fronz F. Batot, Austin, TX (US); Tedrick Neal Northway, Wood River, IL (US); Paul David Peterson, Round Rock, TX (US); Howard Neil Smallowitz, Austin, TX (US); William Alexander Smith, Austin, TX (US); H. William Rinckel, Prospect, CT (US)

Correspondence Address: IBM CORPORATION (RUS);c/o Rudolf O Siegesmund Gordon & Rees, LLp, 2100 Ross Avenue, Suite 2600, DALLAS, TX, 75201, US

(73) Assignee: International Business Machines Corporation, Armonk, NY (US)

(21) Appl. No.: 10/955,183

(22) Filed: Sep. 30, 2004

(51) Int. Cl. G06F 17/60

(52) U.S. Cl. 705/7

(57) ABSTRACT

The invention is a business services method (BSM) for procedures research and analysis, which comprises a process for selecting an appropriate medium for a given set of procedures, business procedure decomposition, and technology decomposition. More particularly, the inventive process comprises: organizing service requirements; collecting data; documenting “source activities,” the intended audience, use of the procedures, and tools to be used; choosing the appropriate media for delivering information to the customer; coordinating teams and defining team requirements; conducting workshops; and sizing the development effort.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention, Business System Management (BSM) Procedures Research and Analysis Methodology relates to service providers delivering procedures as requested by their customers using research and analysis.

### BACKGROUND OF THE INVENTION

A “service” is a familiar concept to most people. An “oil change” is a common example of a service, in which a customer offers to pay “someone” to change the oil in an automobile. In general, the “someone” is known as a service “provider,” and, at least in theory, the provider has the requisite skills and resources for changing the oil in such an automobile. In this instance, the “service” is the labor required to change the oil. When the service is complete, the customer drives away.

Although the customer also may have had the requisite skills and resources for changing oil, the customer found it advantageous to pay someone else to change the oil. Perhaps the customer had the skills, but not the resources, or vice versa. Or perhaps, the customer believed that the resources would be more valuable if used for another purpose. For whatever reason, though, the customer just wanted the oil changed and (probably) did not care how the provider accomplished the task. The customer (probably) also relied upon the service provider to supply the means, processes, procedures, and tools for changing the oil.

Of course, the complexity of a service can vary widely—particularly in an enterprise context. For many years, information technology (IT) organizations (the providers) have offered IT management services to other organizations (the customers). But, again, the customer generally does not care how such a provider accomplishes the tasks, and generally relies upon the provider to supply the means, processes, procedures, and tools for providing the service. In this context, the “service” is any function that the provider is contractually bound to deliver, such as hosting a web site. A “service definition” provides a detailed list of service elements that describe what the provider intends to deliver. The services, as delivered, are documented in “service descriptions.” Service descriptions document each service delivered to each customer and specify precisely the scope, assumptions, service levels, and measurements for each service. Service descriptions also identify the process documents, tools, information, and roles used for the delivery of those services.

Frequently, though, a provider deploys tools before defining or understanding a process, which is a common pitfall. The process maps the flow of work that makes the service successful. Thus, a provider first should define the service and the process, and then assess the tools to insure they have the necessary functionality to support the process. When approached from this perspective, the process maps the flow, the tools execute as required, and the service and the procedures pull it all together to provide a workable model for delivery.

Unlike the oil change provider, though, an IT service provider that intends to deliver a detailed and complex service generally must develop and implement equally detailed and complex processes and procedures. Although often used interchangeably, the terms “process” and “procedure” are distinct in this context. As used here, a “process” is an activity, or group of activities, that takes one or more inputs, adds value, and provides an output. A process uses resources to provide definitive results. A “procedure,” in contrast, is a detailed list of steps that a provider must perform to complete a task. Thus, a procedure attaches specific instructions for the use of the tools, forms, or policies required to execute a process. A procedure generally comprises numbered steps of text descriptions with if-then statements and directions. Workflows, diagrams, and screen shots also often are included in a procedure.

Abundant literature describes the process of writing procedures, but the literature fails to describe adequately the processes of research and analysis that are indispensable for developing effective procedures. Known processes for writing procedures do not consider all the necessary data, analysis, and tool sets. Notably absent from the known processes is any consideration for the type of media in which a provider should deliver procedures. Such processes are limited by an incomplete understanding of the overall effort required for design and development of procedures.

Thus, service providers should benefit from a detailed and integrated process for analyzing the data, activities, and decisions that provide the foundation for developing procedures. Such a process should reduce the cost of transition and delivery, facilitate efficient use of staffing, reduce work duplication, and standardize delivery. The process also should improve the quality of tools and procedures, which are elements of the service; facilitate solution recycling; reduce startup time; and facilitate execution consistency. These and other objects of the invention should be apparent to those skilled in the art from the following detailed description of a preferred embodiment of the invention.

### SUMMARY OF THE INVENTION

The invention is a business services method (BSM) for procedures research and analysis, which comprises a process for selecting an appropriate medium for a given set of procedures, business procedure decomposition, and technology decomposition. More particularly, the inventive process comprises: organizing service requirements; collecting data; documenting “source activities,” the intended audience, use of the procedures, and tools to be used; choosing the appropriate media for delivering information to the customer; coordinating teams and defining team requirements; conducting workshops; and sizing the development effort.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents an overview of general procedure development;

FIG. 2 illustrates the procedure research and analysis workflow;

FIG. 3 represents an embodiment of the source activities analysis;

FIG. 4 represents an embodiment of the audience analysis;

FIG. 5 represents an embodiment of the procedure use analysis;

FIG. 6 illustrates a tool for selecting a medium for delivering procedures; and

FIG. 7 illustrates the process for selecting a medium for delivering procedures.

### DETAILED DESCRIPTION OF THE PREFERRED EMBODIMENT

BSM Procedures Research and Analysis Methodology (PRAM) is a tool that a service provider, particularly in the IT industry, can use to analyze a given process and the technology that enables the process, in preparation for developing procedures. The methodology is based on the premise that, for successful deployment of a service, a provider must have an effective means of determining what procedural documentation currently exists, what desk-level activities need new documentation, and what media should be used for documenting them. PRAM considers all actions between the beginning and the end of a service, regardless of geography, organization or enabling technology. It also considers the locally written documents, project plans, and approaches, which generally are not included or incorporated into the currently known set of documents for any given geography or organization unit. PRAM includes processes, scenarios, questionnaires, media type tables, and tools required to conduct the appropriate research and analysis for creating accurate and user-friendly procedures for a customer.

Policies and standards also influence the development and use of processes, technology and procedures, and PRAM considers them accordingly. As used here, policies and standards are essentially the rules and guidelines that govern a business operation. A “policy” is a self-imposed governing factor defined and controlled by the process implementing body. Policies typically govern operations such as data classification, records retention, actions requiring management approval, procedures for administering system access, and asset protection. A “standard,” in contrast, is a rule, performance criteria, or measurement dictated by an outside authority such as a higher-level process policy, governmental regulating agencies, or industry-accepted norms. Examples of standards include ISO 9000, legal restrictions imposed by governments to protect public health and safety, and ASCA certification.

Generally, a service provider initiates PRAM in response to a customer request for procedures, after the provider and the customer have defined a service and identified the processes and technology necessary for delivering the service. In this context, the customer is any individual or entity that requests a service, documented procedure, or education for performing research and analysis for procedural data gathering. A customer might be either internal or external personnel. In the discussion that follows, the “practitioner” is the service provider who researches and analyzes the information provided by the customer. A “subject matter expert” (SME) is anyone who performs the general tasks for which the customer has requested documented procedures, application developers, technical writers with knowledge of the service, and other technologists familiar with the functionality of the tools that enable the service.

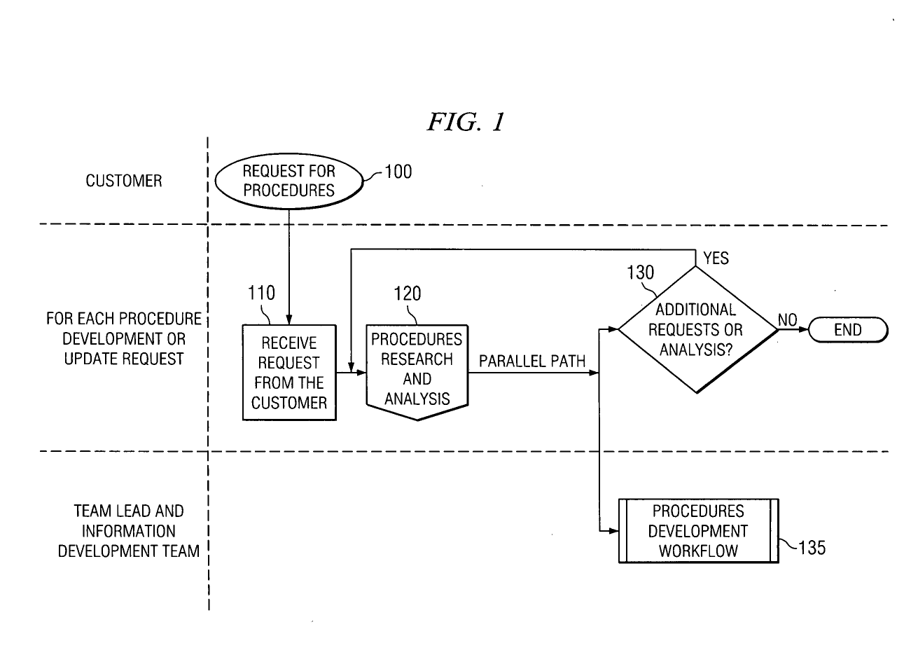

FIG. 1 provides an overview of BSM procedure development, and illustrates how PRAM fits into a larger development process. The customer first requests that the practitioner develop or modify the procedures (100). When the practitioner receives the request from the customer (110), the practitioner initiates the inventive PRAM sub-process (120), which is described in detail below. After the practitioner has completed the research and analysis for the customer's request, the practitioner processes additional requests (130) and develops the procedures (135), as needed.

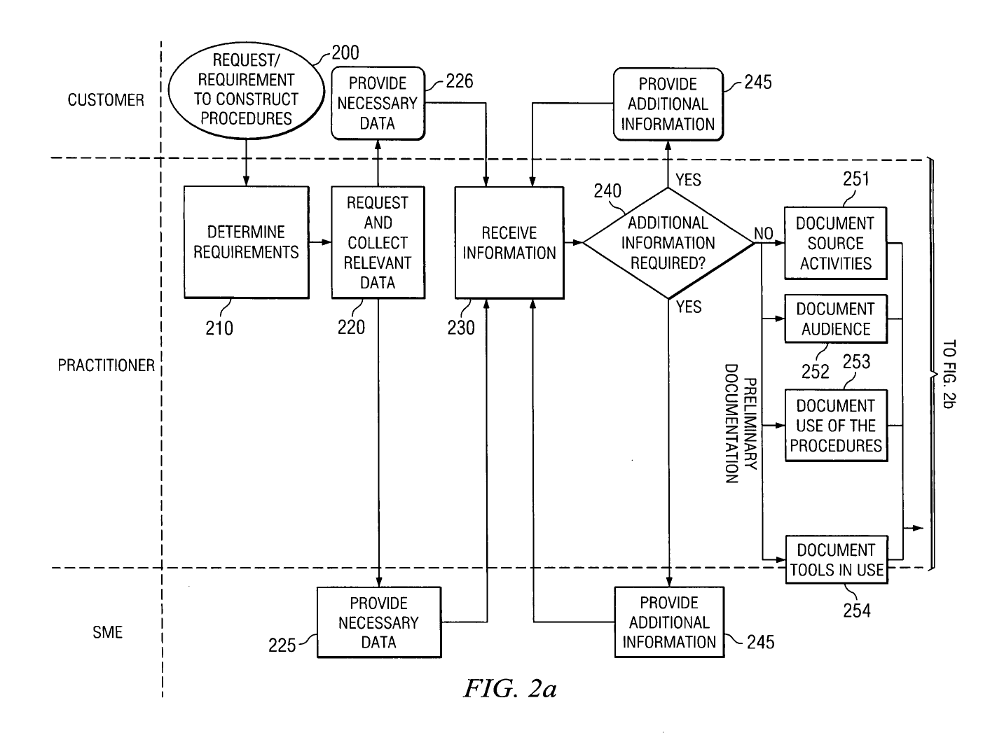

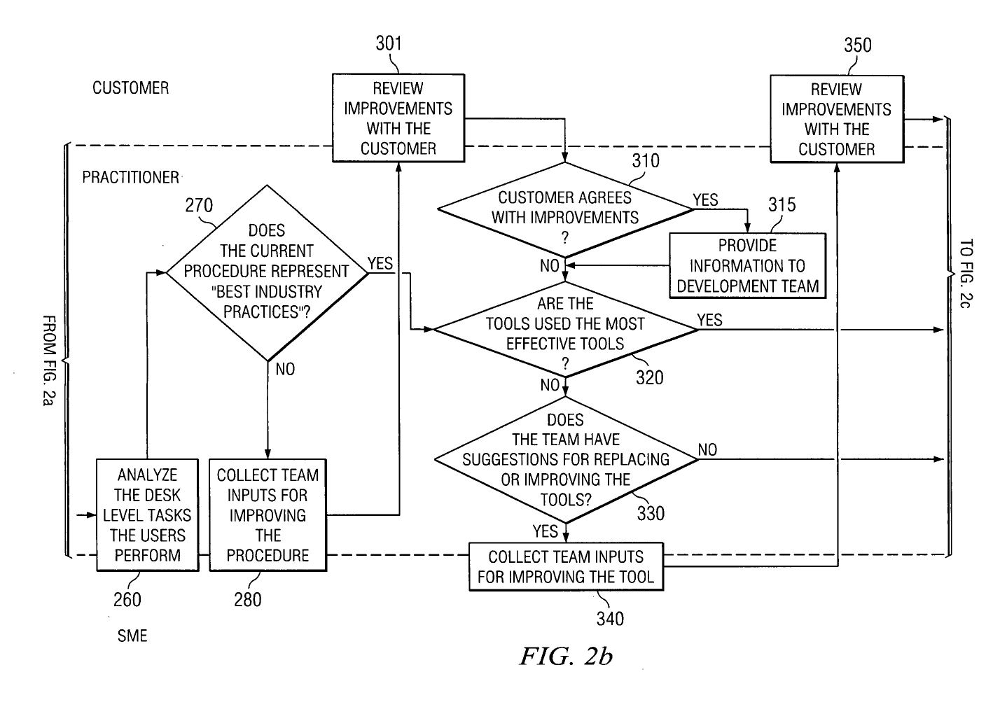

FIG. 2 illustrates PRAM (120). Upon receiving a request to construct procedures, the practitioner reviews the request and notifies the customer that the request is being considered (210). At this time, the practitioner requests relevant and necessary data from the customer and SME (220). Source data includes any existing documentation describing the current technology used for the activities, company policies and processes related to the activities, and forms and other documents used to complete the activities. The customer, the SME, or both, respond to the practitioner's request (225 & 226) with the necessary and relevant data (230). After reviewing the information received from the customer, the practitioner determines if there is enough information to proceed (240). If the practitioner determines that there is not enough information, then the practitioner requests additional information from the customer, SME, or both. The customer, the SME, or both then provide the additional information (245). If no additional information is necessary, then the practitioner proceeds to preliminary documentation, in which the practitioner documents source activities (251), the audience (252), the use of the procedures (253), and the tools (254).

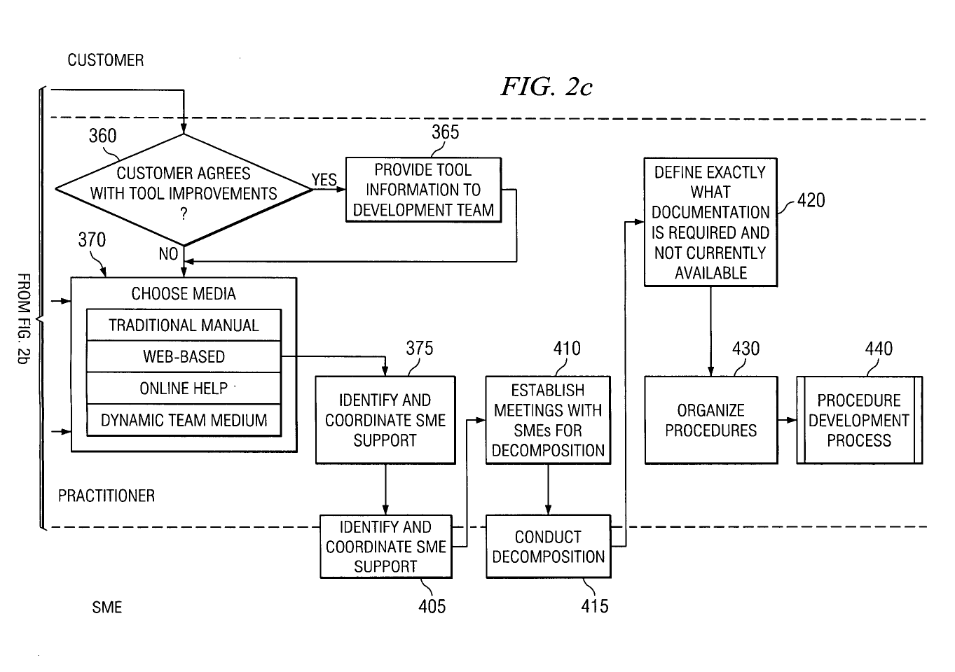

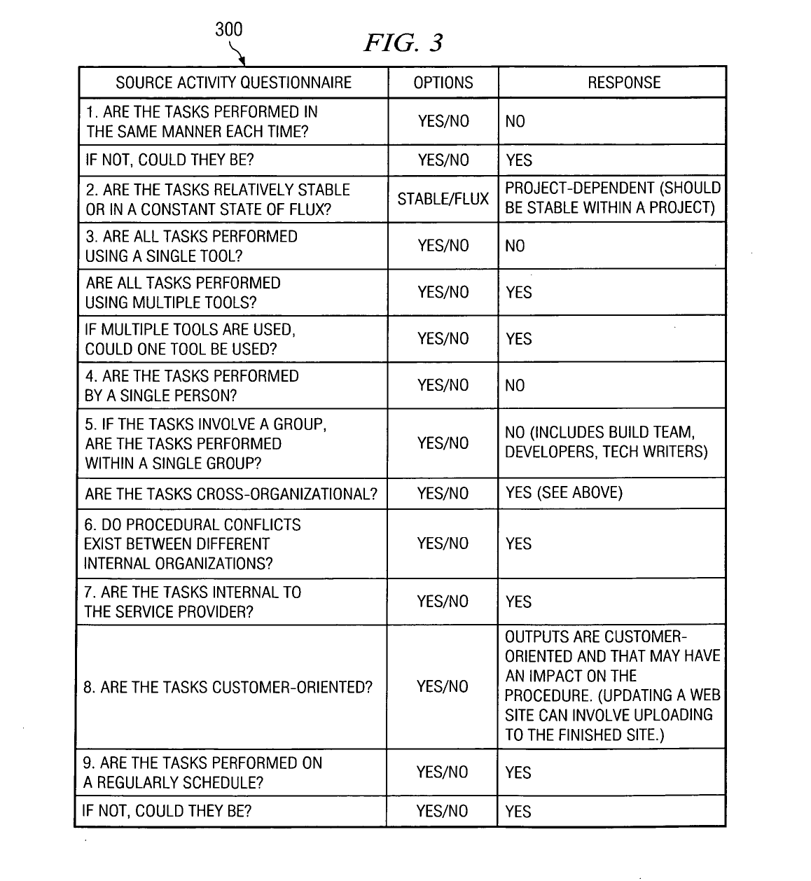

Tables, such as those depicted in FIGS. 3 through 5, are useful tools for organizing the preliminary documentation and the subsequent analysis, which is described in detail below. FIGS. 3 through 5 represent the preliminary documentation that a practitioner has prepared for an exemplary project consisting of developing configuration management (CM) processes and procedures for an Information Development Department. The tasks include developing internal CM processes, transitioning from using multiple CM tools to a single CM tool, and updating a user guide for the selected CM tool.

The source activities are the tasks that the customer has requested the practitioner to describe in the procedures. The practitioner must analyze these activities to determine the media in which to deliver the procedures. Table 300 (see FIG. 3) includes questions that a practitioner has asked a customer or SME in order to analyze the source activities for the exemplary CM project.

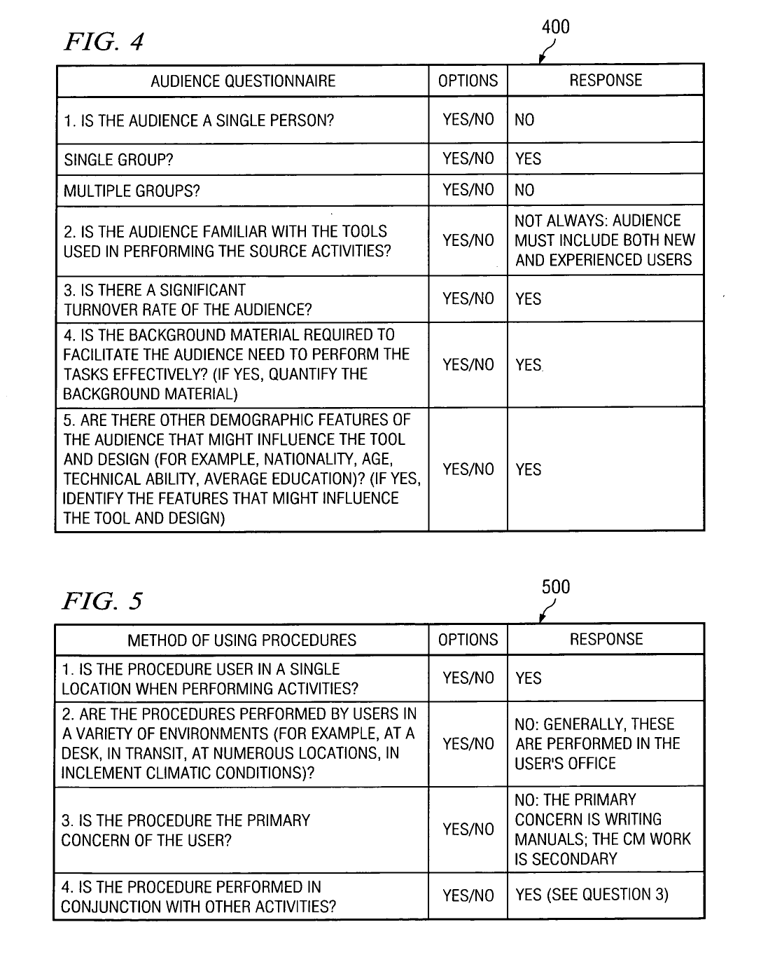

Similarly, table 400 in FIG. 4 includes questions that the practitioner has asked the customer or SME in order to analyze the audience for the exemplary CM project. The audience is the end-user group of the procedures. Some of these factors may seem the same as source activity factors, as described above. While a single person may perform a given task, though, the documented procedures may have an audience consisting of numerous people who use the same tool (and therefore the same manual) in different ways. Consequently, the practitioner must consider the performance of the tasks separately from the audience of the procedures. Note that the practitioner, for the exemplary project, should follow up on the responses to questions 4 and 5 by asking the customer or SME to provide more detail.

Finally, table 500 in FIG. 5 represents the practitioner's analysis of the method for using the procedures in the exemplary CM project. Different audiences may use the procedures in different ways. Thus, the analysis of how the procedures are to be used is closely related to the analysis of source activities. The practitioner should determine all relevant tools used to perform source activities, including software, hardware, mobile devices, and networks. The practitioner also should analyze the tools for stability.

As FIG. 2 illustrates, after preparing the preliminary documentation, the practitioner analyzes a user's desk-level tasks by collecting, organizing, and reviewing all data gathered in the preliminary documentation (260). Based on the analysis of the user's desk-level tasks, the practitioner decides if the procedures represent the best industry practice (270). If the practitioner determines that the procedures do not represent the best industry practice, the practitioner collects team input for improving the procedure (280) and reviews any proposed improvements with the customer (301). The customer then decides if the provider should proceed with the proposed improvements or proceed with the original procedures (310). If the customer approves the proposed improvements, the practitioner provides the proposed improvements to the development team (315).

After resolving any proposed improvements with the customer, or if the procedure already represents the best industry practice, the practitioner proceeds to evaluate the effectiveness of the customer's tools in light of the analysis of the desk-level activities (320). If the practitioner concludes that the customer's tools are not effective, the practitioner proceeds to identify replacements or improvements for the tools (330 and 340), and reviews any such replacements or improvements with the customer (350). The customer then decides if the practitioner should proceed with the new or improved tools, or proceed with the original tools (360). If the customer approves the proposed improvements, the practitioner provides the proposed improvements to the development team (365).

After resolving any tool improvements or replacements, or if the practitioner determines that the existing tools are effective, the practitioner proceeds to select the appropriate media for the procedures (370). In the preferred embodiment, the practitioner considers four basic types of media: a traditional manual, network (or “web-based”) media, “online” help files, and “dynamic” team media. Of course, each medium has unique characteristics, advantages, and disadvantages.

The traditional manual has a long tradition, and its conventions are well-established. It usually has a table of contents and an index to facilitate finding information. It provides background information, in addition to step-by-step instructions. It is usually closely reviewed and well-edited. The manual's structure is primarily linear. Although a digital version may have hypertext links, pages are numbered, and one page follows the next in a linear fashion, in contrast to the other three media, which are all relatively non-linear. A traditional manual is either a mass-produced paper manual or an electronic manual that a user can print one at a time. Traditional manuals are useful in many contexts, including installation instructions, software user manuals, many types of assembly instructions, and reference materials. The practitioner should consider several types of traditional manuals for every project, including: (1) a “planning guide,” (2) an “installation and configuration guide,” (3) an “administration guide,” (4) a “user guide,” (5) an “API developer guide,” and (6) a “problem determination guide.”

A “planning guide” provides a basic description of an application or system, including system and data flow diagrams. If the project is a system or group of application, such a guide provides a description of each component. A planning guide also captures a list of all the prerequisite elements that need to be considered for each new release (such as a list of system hardware and licenses required prior to installation), and provides a high-level overview of the sequence of events involved in a new release, including any dependencies. Generally, a planning guide's audience includes the project manager, system architects, and component leads.

An “installation and configuration guide” provides instructions for an application's or a system's installers. These instructions generally include configuration settings, script files, the order of installation of applications, and data migration information. The installation and configuration guide also references any existing documentation (if existing applications are used within a system), and provides application- or system-specific data to supplement existing installation guides. An installation and configuration guide is detailed and comprehensive, and references existing installation guides as required. Generally, the primary audience for an installation and configuration guide is deployment staff, including installers of the application and system integrators.

An “administration guide” for an application or system describes how to perform application or system-level administration tasks, as well as how to administer or manage an application. An administrator guide might also describe batch processes or other processes that must be performed that are beyond the scope of the primary toolset, and might include instructions related to viewing data store information. The primary audience is the system administrator and, in some cases, application or database administrators.

A “user guide” for an application describes how end-users perform all necessary activities. This guide may have many different users, from sales staff to contract administrators to system architects to billing personnel. For large systems, more than one user guide may be required.

An “API developer guide” defines application programming interfaces (APIs) and design guidelines for developers who need to write code for interfacing products. This guide is only required if an application or system is required to interface with other products.

A “problem determination guide” usually is written after the initial release of a product and draws from the experience of the support team and, if possible, the user groups.

Web-based media are HTML files that are accessible on the Internet or an Intranet. These procedures sometimes describe desk-level activities that are not associated with a single tool (or that go beyond the boundaries of the tool). Web-based procedures provide a versatile medium for presenting instructions. This medium is generally non-linear. Procedures presented through a web-based medium may begin from a central web page, but the procedures generally are linked in such a way that, using hyperlinks, a user can follow any number of paths to find relevant material. The user may or may not return to the central web page for orientation. A table of contents page and an index are recommended, but after finding the initial starting point, the user might prefer to navigate using hyperlink options within the instructions. A web-based medium is particularly useful for procedures that require the use of more than one tool, require a short revision cycle, have numerous choices or branches, or are performed in an environment with constant computer access.

Online help systems consist of help files that provide instructions for a software application. A user generally accesses such help files by clicking a “Help” button on a main menu bar. The user then accesses particular procedures through a hyperlinked table of contents or index, or a search engine. This online help medium is useful for procedures that use a single tool, for which only minimal background information is necessary. This medium is especially useful for context or window-sensitive information. One significant advantage to this medium is that the user can see the instructions on the screen while performing tasks.

A dynamic team medium is any tool that allows documents (including processes and procedures) to be available simultaneously to more than one person; that allows people, either serially or in parallel, to make immediate changes to documents; and that allows a group to immediately view the current version of these documents. Dynamic team media include tools such as LOTUS NOTES TEAM ROOMS and KNOWLEDGE CAFES. A dynamic team medium is appropriate for procedures in a state of constant flux, particularly when team members are discovering and developing processes and procedures, and need to exchange such information. This type of medium, though, is often more difficult to structure and control than the media described above. Consequently, a dynamic team medium is not appropriate for procedures that require close review and editing, or for procedures that require rigorous configuration management. A team medium is more useful for processes and procedures that are at an immature, less stable stage of development. Although a dynamic team medium is very flexible, to be effective, it should be screened and monitored by an administrator. Otherwise, the medium may become cluttered with outdated information, difficult to navigate, and inefficient.

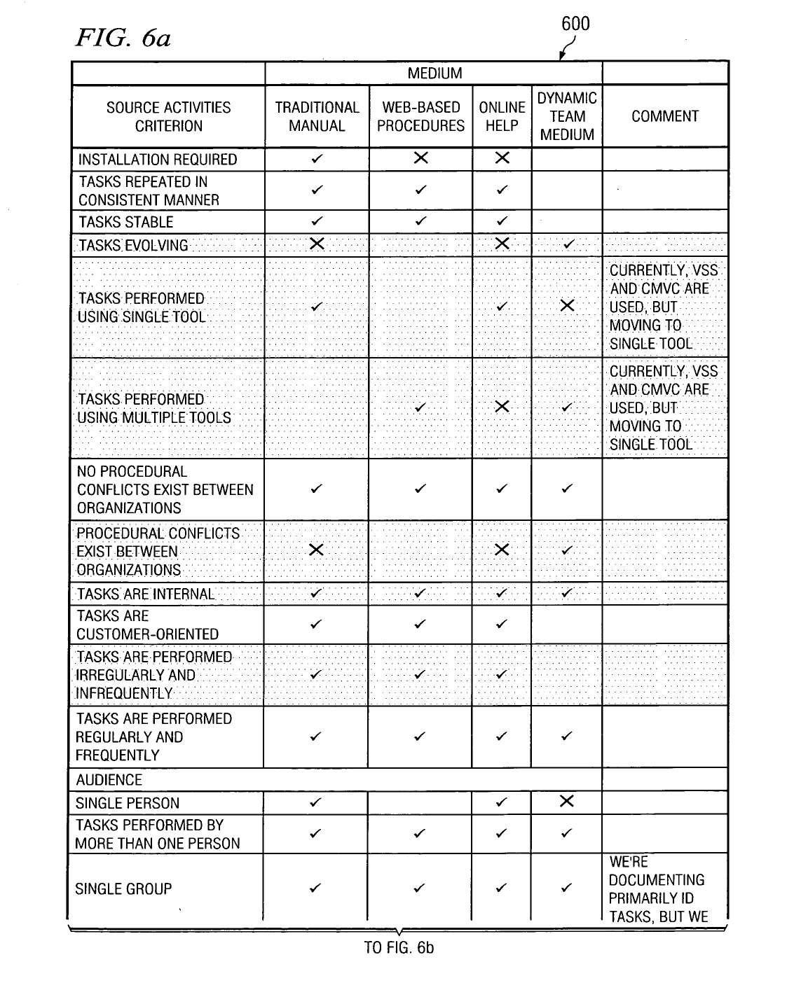

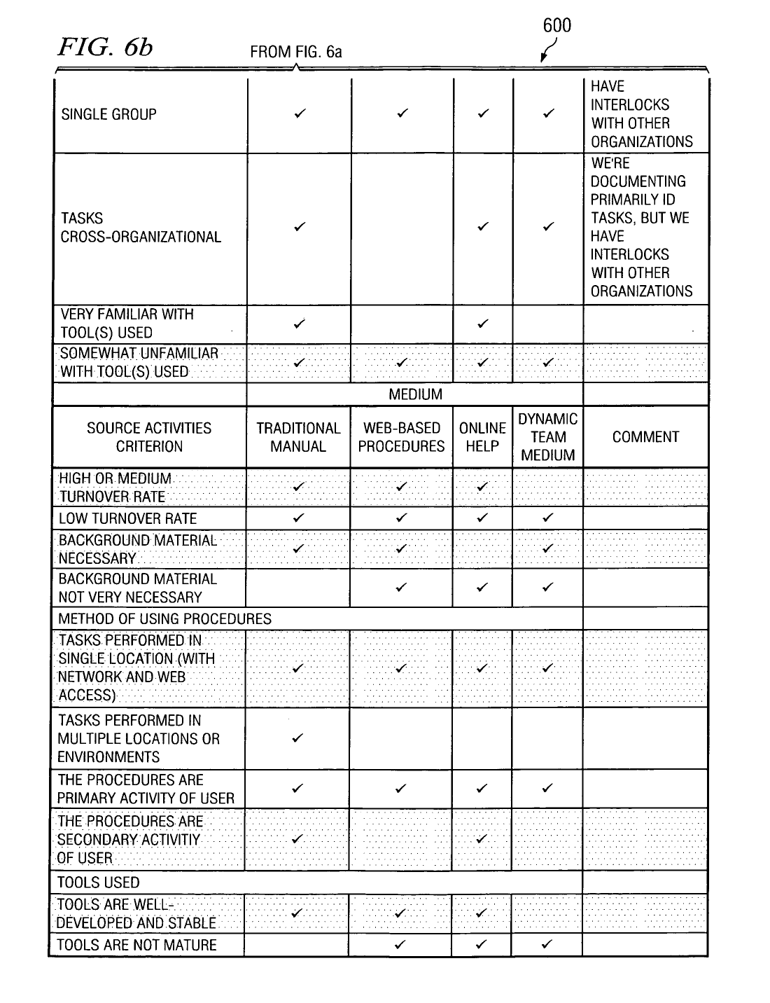

FIG. 6 illustrates table 600, which is designed to support the practitioner's selection of a medium for procedures. Table 600 presents each criterion in isolation, but in practice, the criteria have dependencies. The options for each criterion vary depending on the combination of criteria. For example, even though web-based media are not common for procedures involving a single tool, a practitioner may decide that such media are the optimal selection for tasks or activities that are frequently performed by multiple internal organizations using a single tool. Table 600 represents a practitioner's analysis of the source activities, audience, and method of using procedures for the exemplar CM procedures described above. In table 600, a check mark (√) indicates a medium that is commonly used and recommended for a particular situation, while an “X” indicates that the medium generally is not recommended for a situation. A blank field indicates that use of the medium depends on other factors. A practitioner can determine the most appropriate media simply by counting the number of check marks in each column, and then subtracting at least two for each “X”. For even greater reliability, though, the practitioner should also weight the criteria. For example, if there is strong agreement for “Tasks evolving,” the practitioner should apply a factor of “2” or “3” to that item. When there is not a consensus or strong agreement for an item, the practitioner should leave the value as “1.”

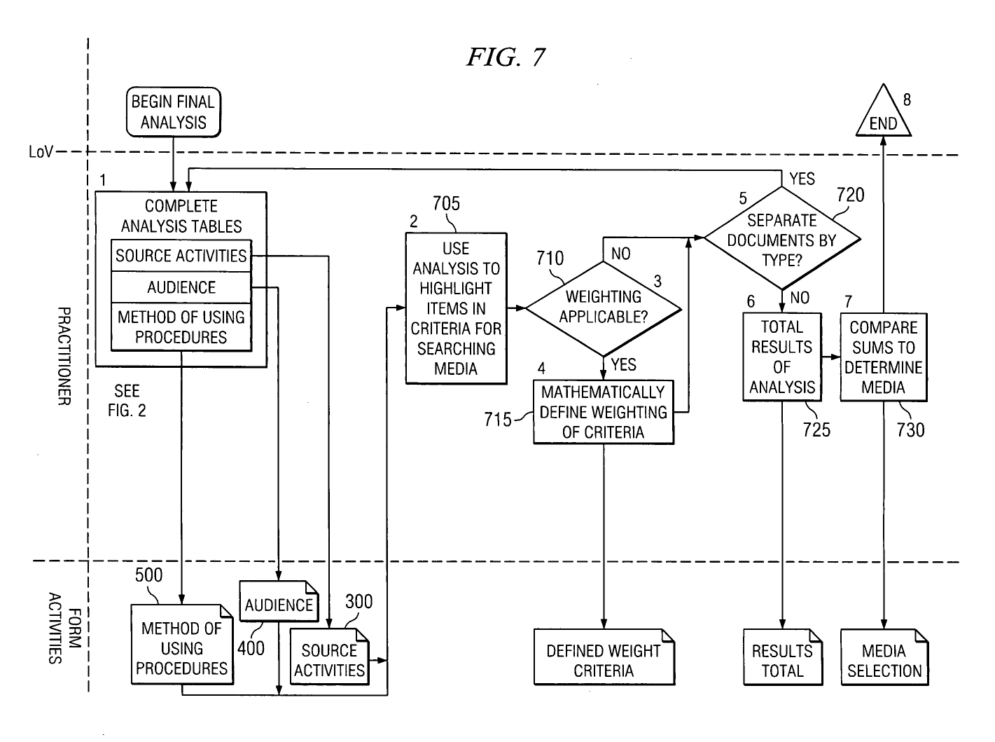

FIG. 7 illustrates the steps for using tables 300, 400, 500, and 600 to determine which medium (or media) best fits the needs of the audience in their work environment. After completing the analysis tables (251 through 253), the practitioner completes table 600 (705). The practitioner then reviews the criteria for selecting document types to determine if “weighting” is appropriate (710). If weighting is appropriate, the practitioner defines the weight of each criterion, as described above (715). After defining the weight of each criterion, or if no weighting is appropriate, the practitioner determines whether documents should be separated by type (720). Generally, the practitioner should separate documents by type if the answers vary significantly from one document type to another, or if different document types are associated with different user groups. If the practitioner determines that the documents should be separated, the practitioner completes the analysis tables (251 through 253) for each document type. The practitioner then adds the values in each column of table 600, as discussed above, and applies weighting factors if appropriate (725). Finally, the practitioner compares the sums of each column of table 600 to determine which media are the strongest candidates for the procedures (730).

Returning again to FIG. 2 for illustration, after selecting the media, the practitioner identifies and coordinates SME support for decomposing the process (405). The practitioner then establishes meetings with the SMEs for the decomposition by arranging meeting rooms and teleconferences, creating an agenda, and sending out notices for the decomposition (410). The practitioner facilitates the decomposition sessions where the list of procedures is compiled (415). This work includes charting the flow of activities, defining the technology used, and determining the format that is required for developing the procedures. The practitioner then defines the required documentation and identifies any required documentation that is not readily available (420). Finally, the practitioner divides the procedure work into manageable groups (430), according to end-user tool, time allowed for documentation, contract requirements, and media selection. This completes decomposition. As illustrated in FIG. 2, the practitioner then is ready to write the procedures (440). As noted above, though, there are many known methods of writing procedures, and ample literature exists on the subject. A person of skill in the art should be able to apply the results of PRAM to any such methods.

As described above, the Procedures Research and Analysis Methodology provides the means to facilitate team efforts and the means to conduct workshops for practitioners. This facility establishes the common approach to analysis, selection of the media, tools to be used, and format of the procedures. It addresses the need and ability to incorporate and capitalize on lessons learned within the environment. It further supports the continuous improvement of the overall procedure development process. Both the customer and the service provider should realize numerous core benefits from implementing such a comprehensive and coherent methodology for analyzing, designing, and creating service oriented procedures. Included among these benefits are: enhanced customer satisfaction with the quality of the service, which the procedures define and support; reduced costs for the service provider as a result of method reuse; risk reduction; shortened design and creation time; and enhanced opportunities for the service provider to identify additional procedures. PRAM also translates into business value. For instance, PRAM enables standardization across different service delivery centers and provides instructional aids to service providers. A service provider also can tailor PRAM to meet contract or other local requirements. Clearly, PRAM represents best practices and includes the key elements of a quality enterprise service delivery.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A business service method for researching and analyzing a procedure to select a medium for delivering the procedure to a customer, the method comprising the steps of:
determining the customer's requirements for procedure development;
requesting and collecting relevant data from the customer;
researching the customer's background and tools;
analyzing the customer's background and tools;
reviewing improvements with the customer;
determining the most effective tools; and
determining the correct media type;
wherein the method takes into consideration the researched and analyzed data and the understanding of how technology is interrelated into the procedure to develop the procedure.

2. The method of claim 1, where the step of researching comprises documenting source activities, an audience, a method of use, and relevant tools to perform source activities.

3. The method of claim 2, where the step of analyzing comprises collecting, organizing, and reviewing the data gathered during the researching.

4. The method of claim 3, where said tools includes software, hardware, mobile devices, and networks.

5. The method of claim 4, further comprising analyzing the tools for stability.

6. The method of claim 1, where the step of determining the correct media type comprises selecting a medium considering the source activities, audience, method of use, and tools.

7. The method of claim 6, where the step of selecting the medium comprises:
populating a medium selection table, the medium selection table comprising a plurality of selectable media and a plurality of criteria, the plurality of criteria comprising
source activities criteria,
audience criteria,
method of use criteria,
tools criteria;
wherein the medium selection table is populated by applying a positive mark to each selectable medium that is recommended for each criterion;
whereby the selectable medium having the maximum number of positive marks is determined to be the correct media type.

8. The method of claim 7, where the step of populating the medium selection table further comprises:
applying a negative mark to each selectable medium that is not recommended for criterion; and
subtracting a number not less than the number of negative marks applied to each selectable medium from the number of positive marks applied to each selectable medium;
whereby the selectable medium having the maximum number of positive marks after subtracting the number is determined to be the correct media type.

9. The method of claim 7, where the step of populating the medium selection table further comprises:
applying a weighting factor to at least one criterion, so that the number of positive marks for each criterion to which the weighting factor is applied is multiplied by the weighting factor;
whereby the selectable medium having the maximum number of positive marks after applying the weighting factor is determined to be the correct media type.

10. The method of claim 8, where the step of populating the medium selection table further comprises:
applying a weighting factor to at least one criterion, so that the number of positive marks for each criterion to which the weighting factor is applied is multiplied by the weighting factor;
whereby the selectable medium having the maximum number of positive marks after subtracting the number and applying the weighting factor is determined to be the correct media type.

11. The method of claim 6, wherein the medium is selected from a group consisting of: a traditional manual, web based medium, online help medium, and a dynamic team medium.

12. The method of claim 7, wherein the medium is selected from a group consisting of: a traditional manual, web based medium, online help medium, and a dynamic team medium.

13. The method of claim 8, wherein the medium is selected from a group consisting of: a traditional manual, web based medium, online help medium, and a dynamic team medium.

14. The method of claim 9, wherein the medium is selected from a group consisting of: a traditional manual, web based medium, online help medium, and a dynamic team medium.

15. The method of claim 10, wherein the medium is selected from a group consisting of: a traditional manual, web based medium, online help medium, and a dynamic team medium.

16. A business service method for researching and analyzing a procedure to select a medium for delivering the procedure to a customer, the method comprising:
steps for decomposing the procedure;
steps for decomposing tools that are operable to implement the procedure;
steps for documenting the procedure's source activities;
steps for documenting the procedure's audience;
steps for documenting the method of using the procedure; and
steps for evaluating the documented source activities, audience, and method of using the procedure to select the medium.
